(19) United States
(12) Patent Application Publication
(10) Pub. No.: US 2007/0205078 A1
(43) Pub. Date: Sep. 6, 2007

(54) Self-checkout terminal

(75) Inventor: Takeshi Tashiro, Shizuoka (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Toshiba Tec Kabushiki Kaisha, Tokyo (JP)

(21) Appl. No.: 11/652,994

(22) Filed: Jan. 12, 2007

(30) Foreign Application Priority Data
Mar. 2, 2006 (JP) 2006-056266

(51) Int. Cl. G07D 5/08

(52) U.S. Cl. 194/317; 194/302

(57) ABSTRACT

A self-checkout terminal is provided which includes a coin recycling machine which stores a coin inserted into a coin inlet in accordance with a denomination of the coin and releases the sorted coin through a coin outlet. A coin receiver receives a coin released through the coin outlet. A coin path couples a coin slot and the coin inlet, and a fake coin path diverges from the coin path toward the coin receiver. A judging unit judges whether a coin inserted into the coin slot is real or fake, and a sorting unit sorts a coin judged to be fake into the fake coin path. When a coin inserted into the coin slot is judged to be fake and is sorted into the fake coin path, information that there is something wrong with the coin is provided to a customer. A coin as change is released through the coin outlet.

### CROSS-REFERENCE TO RELATED APPLICATION

The present application is based on and claims the benefit of priority of Japanese Patent Application P2006-056266 filed on Mar. 2, 2006, the entire contents of which are incorporated herein by reference.

### BACKGROUND OF THE INVENTION

1. Field of the Invention

The present invention relates to a self-checkout terminal for enabling a customer to perform a self-checkout.

2. Description of Related Art

Conventionally, there has been a self-checkout terminal for enabling a customer to perform self-checkout. User interfaces of a self-checkout terminal for performing self-checkout are positioned so as to be operable by a customer. For example, the user interfaces include a scanning unit like a barcode scanner, a display with a touch panel, and a settlement unit like a coin recycling machine for enabling a settlement.

In recent years, counterfeit coins (fake coins) have been a problem. Since a customer may use fake coins for a settlement in self-checkout (intentionally or unintentionally), a coin recycling machine provided in a self-checkout terminal is preferably capable of judging whether an inserted coin is real or fake.

For example, Japanese Patent Laid-Open Publication No. 2000-293730 discloses a coin recycling machine which judges whether an inserted coin is real or fake with a sensor. The coin recycling machine stores only a coin judged to be real, and releases a coin judged to be fake.

However, since the coin recycling machine releases both a coin as change and a coin judged to be fake to the same coin receiver, when the coin recycling machine is provided in a self-checkout terminal, it is hard for a customer to judge whether a released coin is his or her change or a coin judged to be fake. Thus, the customer may be confused.

Accordingly, an object of the present invention is to provide a self-checkout terminal which releases both a coin as change and a coin judged to be fake to the same coin receiver and which informs a customer whether the released coin is change or a coin judge to be fake.

### SUMMARY OF THE INVENTION

According to the present invention, a self-checkout terminal is provided which includes: (i) a scanning unit for scanning at least one merchandise code, (ii) a display, (iii) a coin slot for receiving a coin, (iv) a settlement unit including a coin recycling machine which comprises both a coin inlet and a coin outlet, and which stores the coin inserted into the coin inlet in accordance with a denomination of the coin, and which releases the stored coin through the coin outlet, (v) a coin receiver which receives the coin released through the coin outlet, (vi) a coin path which couples the coin slot and the coin inlet, and which guides the coin inserted into the coin slot to the coin inlet, (vii) a fake coin path which diverges from the coin path toward the coin receiver at a diverging point, and which guides the coin to the coin receiver, (viii) a judging unit which judges whether the coin inserted into the coin slot is real or fake, and which is provided upstream of the diverging point, and (ix) a sorting unit which sorts the coin judged to be fake by the judging unit into the fake coin path. The self-checkout terminal includes a controller which: (i) executes merchandise sales data processing including calculating a settlement price based on the at least one merchandise code scanned by the scanning unit, (ii) executes settlement processing of the calculated settlement price with the settlement unit, (iii) when the coin inserted into the coin slot is judged to be fake by the judging unit and is sorted into the fake coin path by the sorting unit, provides information to a customer that there is something wrong with the coin, and (iv) when making change with the coin is necessary in the settlement processing, causes the coin recycling machine to release the coin as change through the coin outlet.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a perspective view showing a self-checkout terminal;

FIG. 2 is an enlarged perspective view showing a part of a settlement terminal in a state that a part of the base housing is taken off;

FIG. 3 is a perspective view showing a coin recycling machine and a coin selector;

FIG. 4 is a front view showing the coin recycling machine and the coin selector;

FIG. 5 is a block diagram showing an electrical hardware structure of the settlement terminal;

FIG. 6 is a block diagram showing an electrical hardware structure of the coin selector;

FIG. 7 is a flowchart describing a flow of settlement processing;

FIG. 8 is a flowchart describing a flow of coin judgment processing in the coin selector; and

FIG. 9 is a schematic diagram showing an example of a fake coin information screen displayed on a LCD.

### DETAILED DESCRIPTION

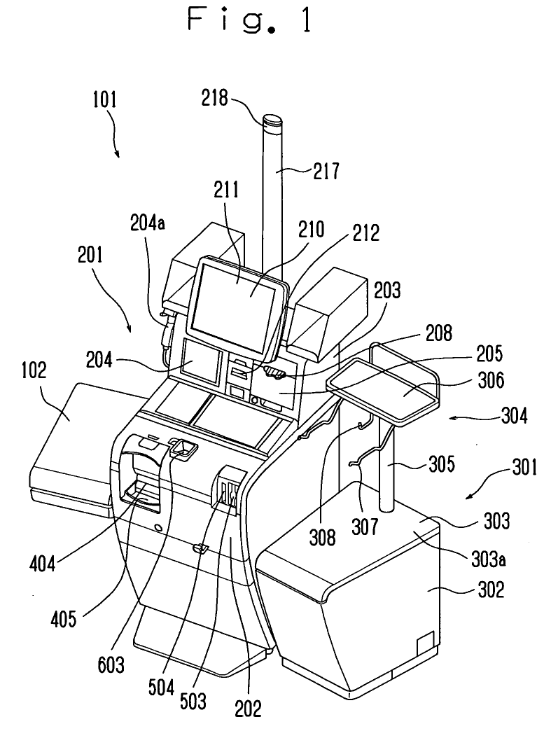

An embodiment of the present invention will be explained with reference to FIGS. 1 to 9.

FIG. 1 is a perspective view showing a self-checkout terminal 101. The self-checkout terminal 101 includes a settlement terminal 201 and a weighing apparatus 301.

The settlement terminal 201 includes a base housing 202 which is placed on a floor of a store and a small upper housing 203 which is set on the base housing 202. At a left side of the base housing 202, a basket placement table 102 for a shopping basket (not shown) to be placed is provided.

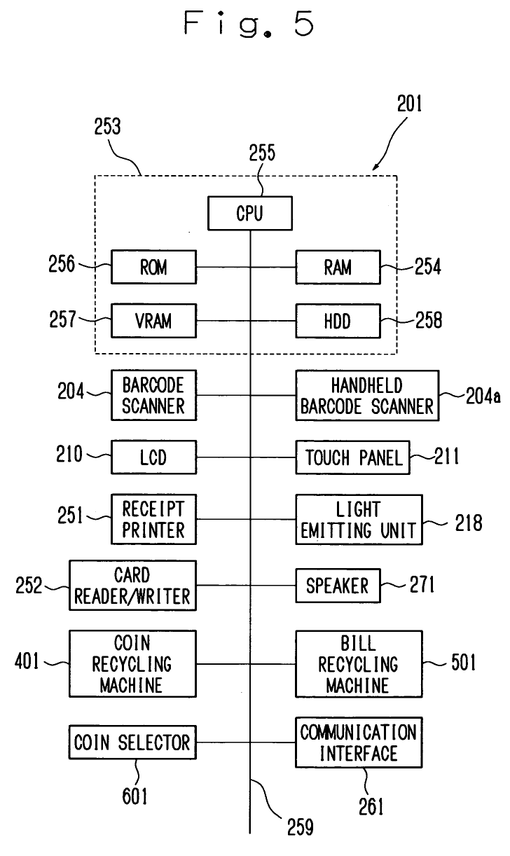

A barcode scanner 204 as a scanning unit is provided at a front left side of the upper housing 203. A printer cover 205 which includes a receipt outlet 208 is provided at a front right side of the upper housing 203. A card slot 212 is provided between the barcode scanner 204 and the printer cover 205. The card slot 212 is part of a card reader/writer 252 (see FIG. 5) which is provided internally in the upper housing 203 internally. A handheld barcode scanner 204a as a scanning unit is provided at a left side of the upper housing 203. The handheld barcode scanner 204a is used for scanning merchandise codes attached to large-size items or heavy items. A receipt printer 251 (see FIG. 5) is provided at a back side of the printer cover 205. A receipt (not shown) printed by the receipt printer 251 is released from the receipt outlet 208. A speaker 271 (see FIG. 5) is provided internally in the upper housing 203.

An LCD 210 is provided as a display in the upper housing 203. A touch panel 211 as an input unit is provided on a display surface of the LCD 210.

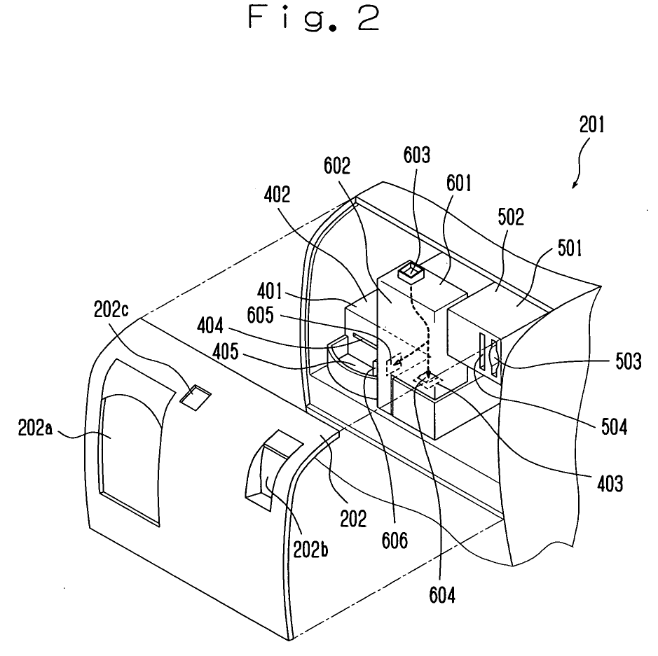

In the base housing 202, a coin recycling machine 401, a bill recycling machine 501, and a coin selector 601 are provided internally (see FIG. 2). A coin slot 603 which is part of the coin selector 601 is provided at a center of a top of the base housing 202. Both a coin outlet 404 and a coin receiver 405 which are part of the coin recycling machine 401 are provided at a left side of the coin slot 603. Both a bill inlet 503 and a bill outlet 504 which are part of the bill recycling machine 501 are provided at front right side of the base housing 202.

At a backside of the base housing 202, an indicating pole 217 is provided to stand upright. The indicating pole 217 indicates a state of the self-checkout terminal 101. The indicating pole 217 includes a light emitting unit 218 at the top. The light emitting unit 218 selectively emits red light and blue light.

As for the weighing apparatus 301, a weighing plate 303 is provided to the upper part of a weighing apparatus housing 302, and a bag holder 304 is provided to the weighing plate 303. The weighing plate 303 includes a placement table 303a on a top surface of the weighing plate 303. The bag holder 304 is provided to the placement table 303a. Therefore, the weighing plate 303 is a pedestal for the bag holder 304. That is to say, a pole-shaped supporter 305 is provided to stand upright at a center of a back part of the placement table 303a, and a temporary placement table 306 is provided at a top of the supporter 305. A top surface of the temporary placement table 306 is a flat plane. The temporary placement table 306 is a table on which a customer places some items temporarily after their barcodes are scanned. A pair of holding arms 307 and a hook 308 are provided to an undersurface of the temporary placement table 306. The holding arms 307 hold a pair of handles of a plastic shopping bag by extending through the handles. Between the handles of the plastic shopping bag, an ear part is provided. The ear part is separable along a perforation line and has a hole. A plastic shopping bag is held by the holding arms 307 and the hook 308, when the hook 308 is inserted into the hole. The weighing apparatus housing 302 includes a loadcell unit (not shown) internally. The loadcell unit translates loads of items which are placed on the weighing plate 303 into electronic signals. Output signals of the loadcell unit are sent to the settlement terminal 201.

FIG. 2 is an enlarged perspective view showing a part of the settlement terminal 201 in a state that a part of the base housing 202 is taken off. In FIG. 2, only the coin recycling machine 401, the bill recycling machine 501, and the coin selector 601 are shown as internal structures of the settlement terminal 201 and the other parts of the settlement terminal 201 are omitted.

An opening mouth 202c is provided at a center of a top surface of the base housing 202. The opening mouth 202c exposes the coin slot 603. Both an opening mouth 202a and an opening mouth 202b are provided at a front of the base housing 202. The opening mouth 202a exposes both the coin outlet 404 and the coin receiver 405. The opening mouth 202b exposes both the bill inlet 503 and the bill outlet 504.

The coin recycling machine 401 has a housing 402. A coin inlet 403, which opens upward, is provided in the housing 402. A part of the housing 402 where the coin inlet 403 is provided projects forward. Both the coin outlet 404 and the coin receiver 405 are provided left of the projecting part of the housing 402. There is a gap between the coin receiver 405 and the projecting part of the housing 402. The coin recycling machine 401 sorts coins which are inserted into the coin inlet 403 into denominations, stores the sorted coins in accordance with their denominations, and releases the stored coins through the coin outlet 404. The coin recycling machine 401 includes a mechanism (not shown) for enabling coin handling and a control unit (not shown) for controlling the coin handling mechanism. Details about a structure of the mechanism and a processing procedure by the control unit are well-known. Therefore, a description of the details will be omitted.

The bill recycling machine 501 is disposed at the upper right of the coin recycling machine 401. The bill recycling machine 501 has a rectangular housing 502. The bill inlet 503 and the bill outlet 504 are provided at a front side of the housing 502. The bill recycling machine 501 sorts bills which are inserted into the bill inlet 503 into denominations, stores the sorted bills in accordance with their denominations, and releases the stored bills through the bill outlet 504. The bill recycling machine 501 includes a mechanism (not shown) for enabling bill handling and a control unit (not shown) for controlling the bill handling mechanism. Details about a structure of the mechanism and a processing procedure by the control unit are well-known. Therefore, a description of the details will be omitted.

The coin selector 601, which has a longitudinally elongated housing 602, is disposed to over the coin inlet 403 of the coin recycling machine 401 so as to cover the coin inlet 403. A coin slot 603, which opens upward, is provided at an upper side of the housing 602. A real coin outlet 604, which opens downward, is provided at an under side of the housing 602 so as to be coupled to the coin inlet 403 of the coin recycling machine 401. The fake coin outlet 605, which opens sideward, is provided at a left side of the housing 602 so as to be coupled to the coin receiver 405. A part of the housing 602 where the fake coin outlet 605 is provided projects downward. This projecting part of the housing 602 is disposed in the gap between the coin receiver 405 and the part of the housing 402 where the coin inlet 403 is provided.

The coin selector 601 sorts a coin inserted into the coin slot 603 in accordance with whether the inserted coin is real or fake, and guides the sorted coin to the real coin outlet 604 or the fake coin outlet 605. A coin guided to the real coin outlet 604 is released to the coin inlet 403. A coin guided to the fake coin outlet 605 is released to the coin receiver 405.

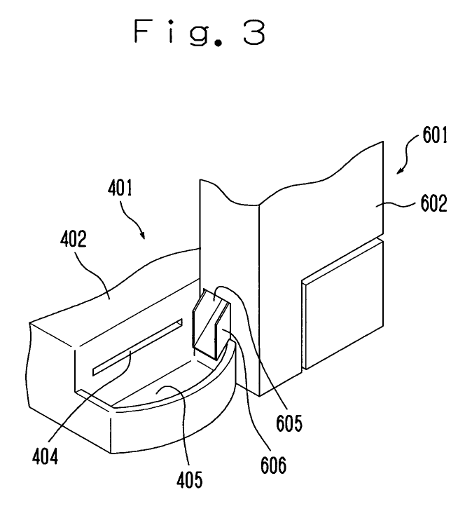

FIG. 3 is a perspective view showing the coin recycling machine 401 and the coin selector 601. The guiding unit 606 is provided to the coin selector 601. The guiding unit 606 connects the fake coin outlet 605 and the coin receiver 405. Thus, a coin released from the fake coin outlet 605 can reach the coin receiver 405 without being dropped elsewhere.

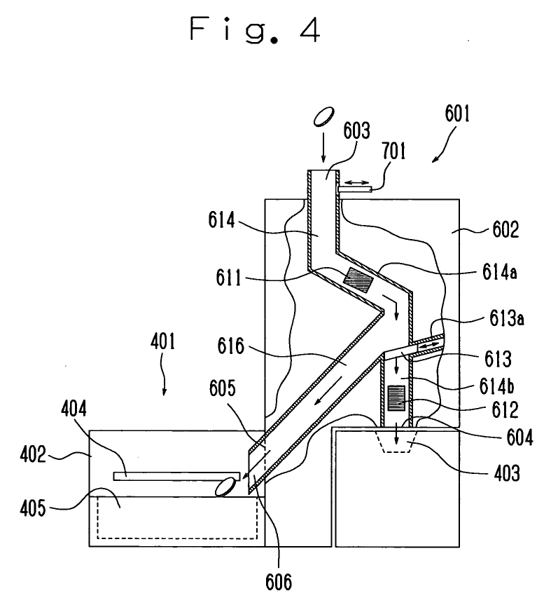

FIG. 4 is a front view showing the coin recycling machine 401 and the coin selector 601. The housing 602 shown in FIG. 4 is partly cut away. Both a coin path 614 and a fake coin path 616 are provided in the housing 602. The coin path 614 connects the coin slot 603 and the real coin outlet 604 to guide a coin which is inserted into the coin slot 603 to the real coin outlet 604. The fake coin path 616 diverges from the coin path 614 and connects to the fake coin outlet 605 to guide a coin to the fake coin outlet 605.

Between the coin slot 603 and the diverging point to the fake coin path 616 in the coin path 614, a first sensor 611 as a judging unit is provided. The first sensor 611 judges whether a coin passing through the coin path 614 from the coin slot 603 is real or fake. For example, the first sensor 611 may be a magnetic sensor sensing material characteristics of coins. Moreover, the first sensor 611 may be a sensor for enabling judging denominations of coins.

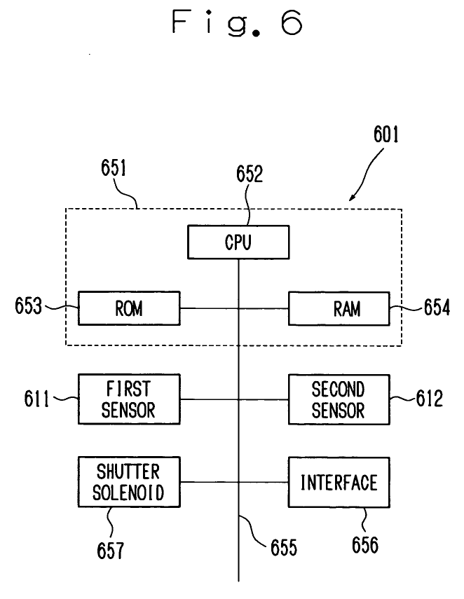

At the diverging point, the shutter 613 as a sorting unit is provided to close the coin path 614. The shutter 613 is linked to the shutter solenoid 657 (see FIG. 6) and is movable between being housed in the shutter holder 613a and being inserted into the coin path 614. When the first sensor 611 judges that a coin inserted into the coin slot 603 is real, the shutter 613 is housed in the shutter holder 613a. When the first sensor 611 judges that a coin inserted into the coin slot 603 is fake, the shutter 613 is inserted into the coin path 614 such that the shutter 613 closes the coin path 614. That is to say, a coin judged to be real is permitted to pass through the coin path 614 due to the shutter 613 being housed in the shutter holder 613a. On the other hand, a coin judged to be fake is sorted into the fake coin path 616 because the shutter 613 closing the coin path 614 prohibits the coin from passing through the coin path 614. A coin permitted to pass through the coin path 614 is released from the real coin outlet 604, and goes to the coin inlet 403 of the coin recycling machine 401. On the other hand, a coin sorted into the fake coin path 616 is guided through the fake coin path 616, is released from the fake coin outlet 605, is guided through the guiding unit 606, and goes to the coin receiver 405.

A second sensor 612, which detects a coin passing through the coin path 614, is provided at a downstream side of the shutter 613 in the coin path 614. The second sensor 612 may, for example, be a light transmission sensor which detects a material body by variations of light transmission.

Hereinafter, a path from the coin slot 603 to the shutter 613 of the coin path 614 will be called a coin path 614a. A path from the shutter 613 to the real coin outlet 604 will be called a coin path 614b.

FIG. 5 is a block diagram showing an electrical hardware structure of the settlement terminal 201. The settlement terminal 201 includes a controller 253 which controls each unit of the settlement terminal 201. The controller 253 includes a CPU 255, a ROM 256 storing fixed data, a RAM 254 storing mutable data so that the mutable data will be freely rewritable, a VRAM 257 generating images displayed on the LCD 210, and a HDD 258. In the HDD 258, operation programs and various files, including a PLU file as a merchandise data file, an image file, a voice file, a sales file, and the like are saved. When the settlement terminal 201 starts up, all or part of the operation programs and the various files are copied onto the RAM 254 so as to be used. In the PLU file, a unit price, weight of a merchandise item, an upper limit and a lower limit for the weight, a merchandise display, and the like which are related to merchandise codes which respectively identify merchandise items are stored so as to be freely rewritable.

The barcode scanner 204, the handheld barcode scanner 204a, the LCD 210, the touch panel 211, the receipt printer 251, the card reader/writer 252, the speaker 271, the light emitting unit 218, the coin recycling machine 401, the bill recycling machine 501, the coin selector 601, and the communication interface 261 for realizing data communication with the weighing apparatus 301 or an attendant terminal (not shown) that monitors a plurality of the self-checkout terminals 101 are connected to the controller 253 through the bus line 259. The controller 253 controls each unit of the settlement terminal 201 and executes various types of processing.

In search processing, when a barcode is scanned by the barcode scanner 204, a merchandise code which is identified by the scanned barcode is recognized, the PLU file is searched, and a unit price, weight, and a merchandise display which are related to the recognized merchandise code are acquired.

Weight check processing judges whether a weight weighed by the weighing apparatus 301 and a weight acquired in the search processing are same or not, by judging whether or not the weight weighed by the weighing apparatus 301 is in between the acquired upper limit and lower limit for the weight.

Merchandise sales data processing is a processing to calculate a settlement price on the basis of a unit price acquired in the search processing and to execute a settlement in the settlement unit. The settlement price will be registered onto the RAM 254 temporarily and will be registered in the sales file. In the present embodiment, a concept of the merchandise sales data processing is used as a broad concept including the search processing, the weight check processing, and the like.

In settlement processing, a settlement of the calculated settlement price using cash (coins or bills) will be possible. The coin recycling machine 401 enables coin handling. The bill recycling machine 501 enables bill handling.

FIG. 6 is a block diagram showing an electrical hardware structure of the coin selector 601. The coin selector 601 includes a controller 651 which controls each unit of the coin selector 601. The settlement terminal 201 is connected to the controller 651 through an interface 656. The controller 651 includes a CPU 652, a ROM 653 storing fixed data such as a control program, and a RAM 654 storing mutable data so that the mutable data will be freely rewritable.

Moreover, the first sensor 611, the second sensor 612, and the shutter solenoid 657 are connected to the controller 651 through the bus line 655. The controller 651 controls each unit of the coin selector 601 and executes coin judgment processing.

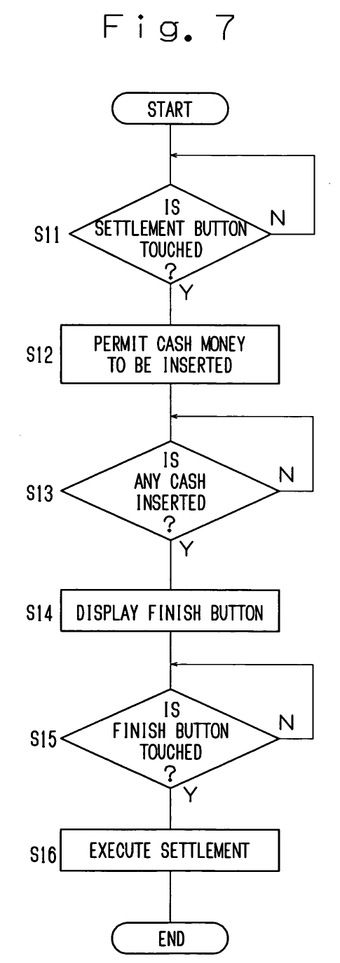

FIG. 7 is a flowchart describing a flow of the settlement processing. The controller 253 of the settlement terminal 201 generates a settlement button (not shown) and displays it on the LCD 210 during execution of the merchandise sales data processing. When the settlement button is touched through the touch panel 211 by a customer who has completed all necessary scanning operations (Y at step S11), the controller 253 executes the settlement processing of a settlement price calculated in the merchandise sales data processing. At this time, the controller 253 permits cash money to be inserted into the coin slot 603 or the bill inlet 503 (step S12). At step S12, the controller 253 opens a coin slot shutter 701 which is provided near the coin slot 603. Then, the controller 253 generates guidance on the inserting of coins into the coin slot 603 or the inserting of bills into the bill inlet 503, and displays the guidance on the LCD 210.

The coin judgment processing executed in the coin selector 601 when a coin is inserted in the coin slot 603 will be described below.

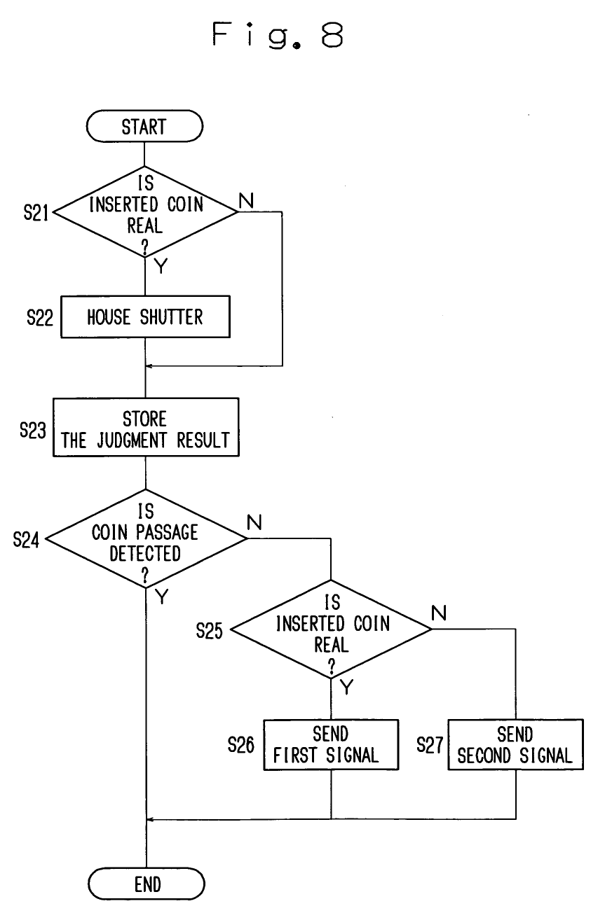

FIG. 8 is a flowchart describing a flow of the coin judgment processing in the coin selector 601. The controller 651 stands by for a judgment of a coin which is inserted into the coin selector 601 by the first sensor 611 (step S21). When the inserted coin is judged to be real by the first sensor 611 (Y at step S21), the controller 651 drives the shutter solenoid 657 to house the shutter 613 in the shutter holder 613a (step S22). Therefore, the real coin is guided through the coin path 614b. A period that the shutter 613 is housed in the shutter holder 613a differs depending on a length of the coin path 614a or a distance from the first sensor 611 to the shutter 613. Then, the controller 651 temporarily stores the judgment result in the RAM 654 (step S23).

On the other hand, at step S21, if the first sensor 611 judges that the inserted coin is fake (N at step S21), the controller 651 temporarily stores the judgment result in the RAM 654 without housing the shutter 613 in the shutter holder 613a (step S23). Then, the coin strikes against the shutter 613 (which is not housed in the shutter holder 613a) and is guided through the fake coin path 616. Thus, the coin is released to the coin receiver 405.

The controller 651 stands by for a detection by the second sensor 612 (step S24). When the second sensor 612 detects passage of a coin (Y at step S24), the controller 651 finishes the processing. At this time, the controller 651 sends a signal informing that the real coin has passed through the coin path 614b to the settlement terminal 201 or the coin recycling machine 401 upon receiving the judgment result stored in the RAM 654.

At step S24, if the second sensor 612 does not detect the passage of a coin (N at step S24), the controller 651 judges whether a coin guided through the coin path 614a is real or fake by referring to the judgment result stored in the RAM 654 (step S25). When a coin guided through the coin path 614a is real (Y at step S25), the controller 651 sends a first signal to the settlement terminal 201 (step S26). The first signal is a signal to inform that a coin judged to be real has not been guided through the coin path 614b. For example, the reason why the coin is not guided through the coin path 614b could be that the shutter 613 is pinching the coin. When the settlement terminal 201 receives the first signal, the settlement terminal 201 may send information on the error to the attendant terminal.

If the second sensor 612 does not detect the passage of a coin (N at step S24) and a coin guided through the coin path 614a is fake (N at step S25), (that is to say, when a coin inserted into the coin slot 603 is judged to be fake by the first sensor 611 and is sorted into the fake coin path 616 by the shutter 613) the controller 651 sends a second signal to the settlement terminal 201 (step S27). The second signal is a signal to inform that a coin inserted into the coin slot 603 is fake.

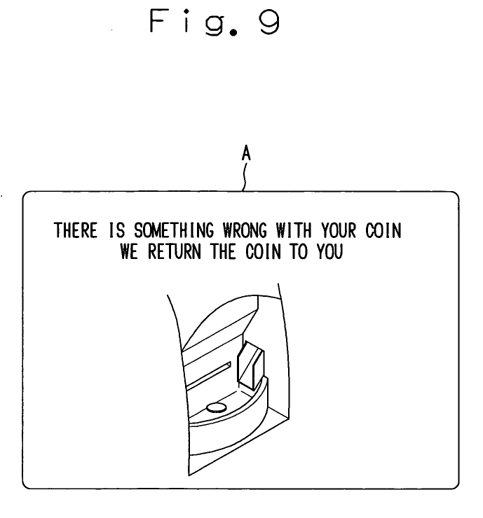

FIG. 9 is a schematic diagram showing an example of a fake coin information screen A displayed on the LCD 210. When the controller 253 of the settlement terminal 201 receives the second signal, the controller 253 generates the fake coin information screen A and displays it on the LCD 210 causes a beep sound to be made. As shown in FIG. 9, the fake coin information screen A includes the text “THERE IS SOMETHING WRONG WITH YOUR COIN WE RETURN THE COIN TO YOU” and an illustration showing the releasing of a coin to the coin receiver 405. By viewing the fake coin information screen A, a customer is informed that a coin released to the coin receiver 405 is not his or her change but a coin which is judged to be fake. At this time, for example, the controller 253 sounds voice information, such as “THERE IS SOMETHING WRONG WITH YOUR COIN”, stored in the voice file through the speaker 271. Therefore, a customer is more certainly informed that a coin released to the coin receiver 405 is not his or her change.

Returning to the flowchart in FIG. 7, when cash money is inserted by a customer (Y at step S13), the controller 253 of the settlement terminal 201 generates a finish button (not shown) and displays the finish button on the LCD 210 (step S14). The finish button is a button for a customer to declare the finishing of the settlement processing of the amount inserted. When the finish button is touched (Y at step S15), the controller 253 executes a settlement of the amount inserted (step S16), and finishes the settlement processing. At step S16, if the amount inserted is more than the settlement price, change is necessary. Thus, the controller 253 drives the coin recycling machine 401 or the bill recycling machine 501 to release coins or bills as change for the customer.

Although both a coin as change and a coin judged to be fake are released to the same coin receiver 405, a customer is informed whether the released coin is a coin judged to be fake or his or her change by the fake coin information screen A, and/or by associated sound and voice information.

Moreover, releasing a coin as change to the coin receiver 405 is not executed unless the finishing of the settlement processing of the amount inserted is chosen by a customer. Therefore, the customer does not need to be confused as to whether the released coin is a coin judged to be fake or a coin as his or her change.

Obviously, numerous modifications and variations of the present invention are possible in light of the above description of the present invention. It is therefore to be understood that within the scope of the appended claims, the invention may be practiced otherwise than as specifically described herein.

What is claimed is:

1. A self-checkout terminal, comprising:
a scanning unit for scanning at least one merchandise code;
a display;
a coin slot for receiving a coin;
a settlement unit including a coin recycling machine which comprises both a coin inlet and a coin outlet, and which stores the coin inserted into the coin inlet in accordance with a denomination of the coin, and which releases the stored coin through the coin outlet;
a coin receiver which receives the coin released through the coin outlet;
a coin path which couples the coin slot and the coin inlet, and which guides the coin inserted into the coin slot to the coin inlet;
a fake coin path which diverges from the coin path toward the coin receiver at a diverging point, and which guides the coin to the coin receiver;
a judging unit which judges whether the coin inserted into the coin slot is real or fake, and which is provided upstream of the diverging point;
a sorting unit which sorts the coin judged to be fake by the judging unit into the fake coin path; and
a controller which: (i) executes merchandise sales data processing including calculating a settlement price based on the at least one merchandise code scanned by the scanning unit, (ii) executes settlement processing of the calculated settlement price with the settlement unit, (iii) when the coin inserted into the coin slot is judged to be fake by the judging unit and is sorted into the fake coin path by the sorting unit, provides information to a customer that there is something wrong with the coin, and (iv) when making change with the coin is necessary in the settlement processing, causes the coin recycling machine to release the coin as change through the coin outlet.

2. The self-checkout terminal according to claim 1, wherein the controller receives an instruction to finish the settlement processing, and the controller causes the coin recycling machine to release the coin as change when the finishing of the settlement processing has been instructed.

3. A self-checkout terminal, comprising:
a display;
a coin slot for receiving a coin;
a settlement unit including a coin recycling machine which comprises both a coin inlet and a coin outlet, and which stores the coin inserted into the coin inlet in accordance with a denomination of the coin, and which releases the stored coin through the coin outlet;
a coin receiver which receives the coin released through the coin outlet;
a coin path which couples the coin slot and the coin inlet, and which guides the coin inserted into the coin slot to the coin inlet;
a fake coin path which diverges from the coin path toward the coin receiver at a diverging point, and which guides the coin to the coin receiver;
a judging unit which judges whether the coin inserted into the coin slot is real or fake, and which is provided upstream of the diverging point;
a sorting unit which sorts the coin judged to be fake by the judging unit into the fake coin path; and
a controller which: (i) executes merchandise sales data processing including calculating a settlement price based on input data of merchandise to be purchased, (ii) executes settlement processing of the calculated settlement price with the settlement unit, (iii) when the coin inserted into the coin slot is judged to be fake by the judging unit and is sorted into the fake coin path by the sorting unit, provides information to a customer that there is something wrong with the coin, and (iv) when making change with the coin is necessary in the settlement processing, causes the coin recycling machine to release the coin as change through the coin outlet.

4. The self-checkout terminal according to claim 3, wherein the controller receives an instruction to finish the settlement processing, and the controller causes the coin recycling machine to release the coin as change when the finishing of the settlement processing has been instructed.
